(19) United States
(12) Patent Application Publication
(10) Pub. No.: US 2026/0200330 A1
(43) Pub. Date: Jul. 16, 2026

(54) SYSTEMS, METHODS, AND STORAGE MEDIUM FOR CONTROLLING HYDROGEN REFUELING ACTIONS OF FUEL CELL VEHICLES

(71) Applicants: CATARC NEW ENERGY VEHICLE TEST CENTER (TIANJIN) CO., LTD., Tianjin (CN); CHINA AUTOMOTIVE TECHNOLOGY & RESEARCH CENTER CO., LTD., Tianjin (CN)

(72) Inventors: Zirong YANG, Tianjin (CN); Dong HAO, Tianjin (CN); Yanyi ZHANG, Tianjin (CN); Fang WANG, Tianjin (CN); Xiangyang CHEN, Tianjin (CN); Yunpeng YANG, Tianjin (CN); Jia WANG, Tianjin (CN); Wenyan DONG, Tianjin (CN); Zhensen DING, Tianjin (CN); Xiangxiang WANG, Tianjin (CN)

(73) Assignees: CATARC NEW ENERGY VEHICLE TEST CENTER (TIANJIN) CO., LTD., Tianjin (CN); CHINA AUTOMOTIVE TECHNOLOGY & RESEARCH CENTER CO., LTD., Tianjin (CN)

(21) Appl. No.: 19/564,139

(22) Filed: Mar. 11, 2026

Related U.S. Application Data
(63) Continuation-in-part of application No. 18/816,365, filed on Aug. 27, 2024.

(30) Foreign Application Priority Data
Nov. 6, 2023 (CN) 202311466486.3

(51) Int. Cl. B60L 3/08; B60L 15/20; B60L 58/30; B60S 5/02; G07C 5/04; H01M 8/04089; H01M 8/04746

(52) U.S. Cl. CPC B60L 3/08; B60L 15/20; B60L 58/30; B60S 5/02; G07C 5/04; H01M 8/04089; H01M 8/04753; B60L 2240/12; B60L 2240/429; B60L 2240/64; B60L 2240/662; H01M 2250/20

(57) ABSTRACT

Disclosed are a system, a method, and storage medium for controlling a hydrogen refueling action of a fuel cell vehicle. The method includes: obtaining a structural design parameter of a hydrogen system of the fuel cell vehicle and a driving data set of the fuel cell vehicle; determining a first hydrogen refueling feature set and a second hydrogen refueling feature set of the fuel cell vehicle; determining whether the fuel cell vehicle is in a high hydrogen consumption state; generating a consumption reduction command and sending the consumption reduction command to a vehicle control unit; and controlling, by the vehicle control unit based on the consumption reduction command, a fuel cell control unit (FCU) to adjust an injection frequency of a hydrogen injector, and controlling a motor control unit (MCU) to set a peak threshold of a stator current to limit a maximum phase current of a motor.

### CROSS-REFERENCE TO RELATED APPLICATIONS

This application is a continuation-in-part of U.S. patent application Ser. No. 18/816,365, filed on Aug. 27, 2024, which claims priority of Chinese Patent Application No. 202311466486.3, filed on Nov. 6, 2023, and the contents of which are hereby incorporated by reference.

### TECHNICAL FIELD

The present disclosure generally relates to the technical field of fuel cells, and in particular to a system, a method, and a storage medium for controlling a hydrogen refueling action of a fuel cell vehicle.

### BACKGROUND

Different from traditional internal combustion engine vehicles that use fossil fuels such as gasoline, diesel, or natural gas, a fuel cell vehicle uses hydrogen as an energy carrier. Operation of the fuel cell vehicle relies on a continuous and stable supply of hydrogen. However, current construction of hydrogen refueling stations suffers from problems such as scattered layout and low coverage, leading to insufficient convenience for hydrogen refueling. Meanwhile, hydrogen refueling features such as hydrogen refueling mass and average hydrogen consumption of the fuel cell vehicle during actual operation lack systematic monitoring, which directly affects evaluation of user usage cost and decision making of hydrogen refueling station planning.

Existing technologies have not established an effective analysis system to evaluate energy dependence characteristics of the fuel cell vehicle under actual operation conditions. Especially in planning and layout of hydrogen refueling stations, a lack of scientific decision-making basis based on massive operation data causes a disconnection between infrastructure construction and actual demand of the fuel cell vehicle. Traditional analysis methods are limited by factors such as a small count of samples, limited geographical coverage, and high implementation costs. As a result, traditional analysis methods have difficulty in comprehensively reflecting real operation features of the fuel cell vehicle.

Therefore, it is desirable to provide a system, a method, and a storage medium for controlling a hydrogen refueling action of a fuel cell vehicle, which can combine a big data platform to realize analysis of the hydrogen refueling action of the fuel cell vehicle.

### SUMMARY

One or more embodiments of the present disclosure provide a system for controlling a hydrogen refueling action of a fuel cell vehicle. The system includes a vehicle control unit. The vehicle control unit is configured to: obtain a structural design parameter of a hydrogen system of the fuel cell vehicle and a driving data set of the fuel cell vehicle in a preset time period from a big data platform of the fuel cell vehicle. The structural design parameter of the hydrogen system of the fuel cell vehicle includes at least one of a count of hydrogen storage tanks, a nominal water volume of each of the hydrogen storage tanks, and a nominal operating pressure of each of the hydrogen storage tanks. The vehicle control unit is configured to obtain a hydrogen refueling data set related to the hydrogen refueling action of the fuel cell vehicle based on the driving data set. The hydrogen refueling data set of the hydrogen refueling action of the fuel cell vehicle includes at least one of an information sending time, a cumulative mileage, a maximum temperature in the hydrogen system, and a maximum hydrogen pressure. The vehicle control unit is configured to identify occurrence of the hydrogen refueling action of the fuel cell vehicle by using a preset judgement condition based on the hydrogen refueling data set, and determine attribute change values of the fuel cell vehicle after the occurrence of the hydrogen refueling action of the fuel cell vehicle based on respective data rows before and after hydrogen refueling of the fuel cell vehicle. The vehicle control unit is configured to calculate hydrogen refueling mass of the fuel cell vehicle based on the attribute change values of the fuel cell vehicle after the occurrence of the hydrogen refueling action of the fuel cell vehicle. The vehicle control unit is configured to obtain a first hydrogen refueling feature set of the fuel cell vehicle based on the hydrogen refueling data set. The first hydrogen refueling feature set of the fuel cell vehicle includes at least one of a pressure of each of the hydrogen storage tanks before hydrogen refueling of the fuel cell vehicle, a pressure of each of the hydrogen storage tanks after hydrogen refueling of the fuel cell vehicle, a temperature of each of the hydrogen storage tanks before hydrogen refueling of the fuel cell vehicle, and a temperature of each of the hydrogen storage tanks after hydrogen refueling of the fuel cell vehicle. The vehicle control unit is configured to obtain a second hydrogen refueling feature set corresponding to all hydrogen refueling actions in the hydrogen refueling data set based on the hydrogen refueling data set and the first hydrogen refueling feature set of the fuel cell vehicle. The second hydrogen refueling feature set includes at least one of a hydrogen refueling interval distance, a hydrogen refueling interval time, a count of hydrogen refueling operations, the hydrogen refueling mass, and average hydrogen consumption. The vehicle control unit is configured to determine whether the fuel cell vehicle is in a high hydrogen consumption state based on the average hydrogen consumption and reference hydrogen consumption. The vehicle control unit is configured to generate a consumption reduction command based on the average hydrogen consumption and the reference hydrogen consumption in response to the fuel cell vehicle being in the high hydrogen consumption state. The vehicle control unit is configured to control a fuel cell control unit (FCU) to adjust an injection frequency of a hydrogen injector and control a motor control unit (MCU) to set a peak threshold of a stator current to limit a maximum phase current of a motor based on the consumption reduction command.

One or more embodiments of the present disclosure provide a method for controlling a hydrogen refueling action of a fuel cell vehicle. The method includes: obtaining a structural design parameter of a hydrogen system of the fuel cell vehicle and a driving data set of the fuel cell vehicle in a preset time period from a big data platform of the fuel cell vehicle. The structural design parameter of the hydrogen system of the fuel cell vehicle includes at least one of a count of hydrogen storage tanks, a nominal water volume of each of the hydrogen storage tanks, and a nominal operating pressure of each of the hydrogen storage tanks. The method includes obtaining a hydrogen refueling data set related to the hydrogen refueling action of the fuel cell vehicle based on the driving data set. The hydrogen refueling data set of the hydrogen refueling action of the fuel cell vehicle includes at least one of an information sending time, a cumulative mileage, a maximum temperature in the hydrogen system, and a maximum hydrogen pressure. The method includes identifying occurrence of the hydrogen refueling action of the fuel cell vehicle by using a preset judgement condition based on the hydrogen refueling data set, and determining attribute change values of the fuel cell vehicle after the occurrence of the hydrogen refueling action of the fuel cell vehicle based on respective data rows before and after hydrogen refueling of the fuel cell vehicle. The method includes calculating hydrogen refueling mass of the fuel cell vehicle based on the attribute change values of the fuel cell vehicle after the occurrence of the hydrogen refueling action of the fuel cell vehicle. The method includes obtaining a first hydrogen refueling feature set of the fuel cell vehicle based on the hydrogen refueling data set. The first hydrogen refueling feature set of the fuel cell vehicle includes at least one of a pressure of each of the hydrogen storage tanks before hydrogen refueling of the fuel cell vehicle, a pressure of each of the hydrogen storage tanks after hydrogen refueling of the fuel cell vehicle, a temperature of each of the hydrogen storage tanks before hydrogen refueling of the fuel cell vehicle, and a temperature of each of the hydrogen storage tanks after hydrogen refueling of the fuel cell vehicle. The method includes obtaining a second hydrogen refueling feature set corresponding to all hydrogen refueling actions in the hydrogen refueling data set based on the hydrogen refueling data set and the first hydrogen refueling feature set of the fuel cell vehicle. The second hydrogen refueling feature set includes at least one of a hydrogen refueling interval distance, a hydrogen refueling interval time, a count of hydrogen refueling operations, the hydrogen refueling mass, and average hydrogen consumption. The method includes determining whether the fuel cell vehicle is in a high hydrogen consumption state based on the average hydrogen consumption and reference hydrogen consumption. The method includes generating a consumption reduction command based on the average hydrogen consumption and the reference hydrogen consumption and sending the consumption reduction command to a vehicle control unit in response to the fuel cell vehicle being in the high hydrogen consumption state; and controlling, by the vehicle control unit based on the consumption reduction command, an FCU to adjust an injection frequency of a hydrogen injector, and controlling an MCU to set a peak threshold of a stator current to limit a maximum phase current of a motor.

One or more embodiments of the present disclosure provide a non-transitory computer-readable storage medium. The storage medium stores computer instructions. When a computer reads the computer instructions in the storage medium, the computer executes the method for controlling the hydrogen refueling action of the fuel cell vehicle described above.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a block diagram illustrating an exemplary system for controlling a hydrogen refueling action of a fuel cell vehicle according to some embodiments of the present disclosure;

FIG. 2 is a flowchart illustrating an exemplary method for controlling a hydrogen refueling action of a fuel cell vehicle according to some embodiments of the present disclosure;

FIG. 3 is a schematic diagram illustrating an exemplary process of determining hydrogen refueling of a fuel cell vehicle according to some embodiments of the present disclosure;

FIG. 4 is a schematic diagram illustrating a distribution of hydrogen refueling interval distances of a fuel cell vehicle according to some embodiments of the present disclosure;

FIG. 5 is a schematic diagram illustrating a distribution of hydrogen refueling interval times of a fuel cell vehicle according to some embodiments of the present disclosure;

FIG. 6 is a schematic diagram illustrating a distribution of hydrogen refueling interval distances and hydrogen refueling interval times of a fuel cell vehicle according to some embodiments of the present disclosure;

FIG. 7 is a schematic diagram illustrating a probability distribution of hydrogen refueling interval distances and hydrogen refueling interval times of a fuel cell vehicle according to some embodiments of the present disclosure;

FIG. 8 is a schematic diagram illustrating a distribution of a pressure of each of hydrogen storage tanks before and after hydrogen refueling of a fuel cell vehicle according to some embodiments of the present disclosure;

FIG. 9 is a schematic diagram illustrating a distribution of single hydrogen refueling mass of a fuel cell vehicle according to some embodiments of the present disclosure;

FIG. 10 is a schematic diagram illustrating a distribution of average hydrogen consumption per hundred kilometers of a fuel cell vehicle according to some embodiments of the present disclosure.

### DETAILED DESCRIPTION

To more clearly illustrate the technical solutions in the embodiments of the present disclosure, the drawings used in the description of the embodiments will be briefly introduced below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

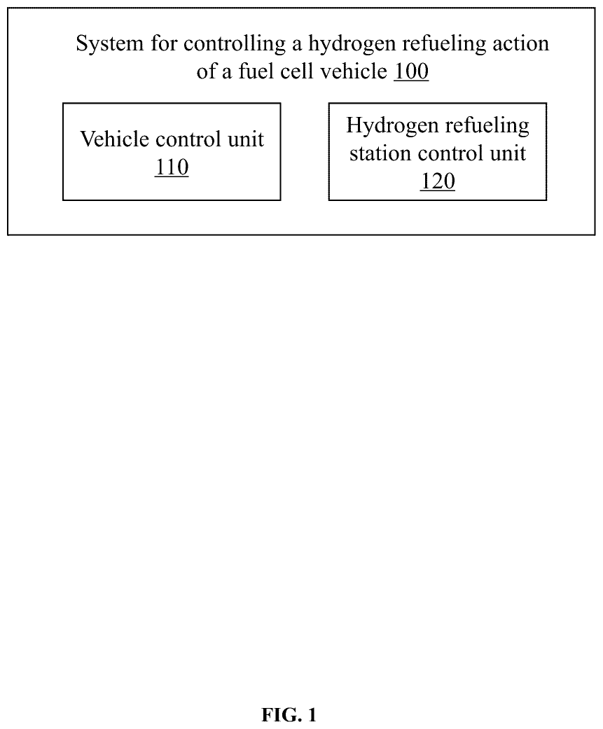

FIG. 1 is a block diagram illustrating an exemplary system for controlling a hydrogen refueling action of a fuel cell vehicle according to some embodiments of the present disclosure.

In some embodiments, as shown in FIG. 1, a system for controlling a hydrogen refueling action of a fuel cell vehicle 100 (or the system 100) includes a vehicle control unit 110 and a hydrogen refueling station control unit 120.

The vehicle control unit 110 refers to a core control module of the fuel cell vehicle. The vehicle control unit 110 is responsible for coordinating and managing operations of various subsystems (e.g., a motor, a battery, an engine, or the like) in the fuel cell vehicle.

In some embodiments, the vehicle control unit 110 is configured to: obtain a structural design parameter of a hydrogen system of the fuel cell vehicle and a driving data set of the fuel cell vehicle in a preset time period from a big data platform of the fuel cell vehicle; obtain a hydrogen refueling data set related to the hydrogen refueling action of the fuel cell vehicle based on the driving data set; identify occurrence of the hydrogen refueling action of the fuel cell vehicle by using a preset judgement condition based on the hydrogen refueling data set, and determine attribute change values of the fuel cell vehicle after the occurrence of the hydrogen refueling action of the fuel cell vehicle based on respective data rows before and after hydrogen refueling of the fuel cell vehicle; calculate hydrogen refueling mass of the fuel cell vehicle based on the attribute change values of the fuel cell vehicle after the occurrence of the hydrogen refueling action of the fuel cell vehicle; obtain a first hydrogen refueling feature set of the fuel cell vehicle based on the hydrogen refueling data set; obtain a second hydrogen refueling feature set corresponding to all hydrogen refueling actions in the hydrogen refueling data set based on the hydrogen refueling data set and the first hydrogen refueling feature set of the fuel cell vehicle; determine whether the fuel cell vehicle is in a high hydrogen consumption state based on average hydrogen consumption and reference hydrogen consumption; in response to the fuel cell vehicle being in the high hydrogen consumption state, generate a consumption reduction command based on the average hydrogen consumption and the reference hydrogen consumption; and control a fuel cell unit (FCU) to adjust an injection frequency of a hydrogen injector and control a motor control unit (MCU) to set a peak threshold of a stator current to limit a maximum phase current of a motor based on the consumption reduction command.

In some embodiments, the vehicle control unit 110 is further configured to: in response to the fuel cell vehicle being in the high hydrogen consumption state, construct a hydrogen consumption reference library of the fuel cell vehicle based on a plurality of historical second hydrogen refueling feature sets of the fuel cell vehicle, historical ambient temperatures, and historical road condition information; determine a remaining hydrogen quantity of each of the hydrogen storage tanks based on pressure data and temperature data of each of the hydrogen storage tanks; determine predicted hydrogen consumption of the fuel cell vehicle in a future time period based on road condition information and ambient temperatures through the hydrogen consumption reference library; determine an injection frequency sequence and a peak threshold sequence based on the road condition information, the remaining hydrogen quantity, and the predicted hydrogen consumption; generate a frequency control command and a peak control command based on the injection frequency sequence and the peak threshold sequence; control the FCU to adjust the injection frequency of the hydrogen injector for at least one future moment based on the frequency control command; and control the MCU to set the peak threshold of the stator current for the at least one future moment based on the peak control command.

In some embodiments, the vehicle control unit 110 is further configured to: when the remaining hydrogen quantity is less than a preset hydrogen quantity threshold, determine a target hydrogen refueling station based on a mean value of hydrogen refueling interval distances in the plurality of historical second hydrogen refueling feature sets, the road condition information, and the remaining hydrogen quantity, and generate a navigation command to guide the fuel cell vehicle to the target hydrogen refueling station.

In some embodiments, the vehicle control unit 110 is further configured to: in response to the first hydrogen refueling feature set satisfying an overpressure condition, generate a mode switching command; and force the fuel cell vehicle to switch to a limp mode based on the mode switching command.

The hydrogen refueling station control unit 120 refers to a core control module of a hydrogen refueling station. The hydrogen refueling station control unit 120 is responsible for coordinating and managing operations of various subsystems (e.g., a hydrogen dispenser, or the like) in the hydrogen refueling station.

In some embodiments, the hydrogen refueling station control unit 120 is configured to: in response to receiving a hydrogen refueling feature request, generate a hydrogen refueling feature of the fuel cell vehicle based on the structural design parameter, the first hydrogen refueling feature set, and the second hydrogen refueling feature set; send the hydrogen refueling feature to a hydrogen dispenser; and generate, by the hydrogen dispenser based on the hydrogen refueling feature, a hydrogen refueling pressure and a hydrogen refueling flow rate, and refuel the fuel cell vehicle based on the hydrogen refueling pressure and the hydrogen refueling flow rate.

In some embodiments, the hydrogen refueling station control unit 120 is further configured to: in response to receiving a hydrogen refueling state request, determine a hydrogen refueling state of the fuel cell vehicle based on the first hydrogen refueling feature set and the second hydrogen refueling feature set; send the hydrogen refueling state to the hydrogen dispenser; and determine, by the hydrogen dispenser, whether to lock a hydrogen refueling nozzle based on the hydrogen refueling state.

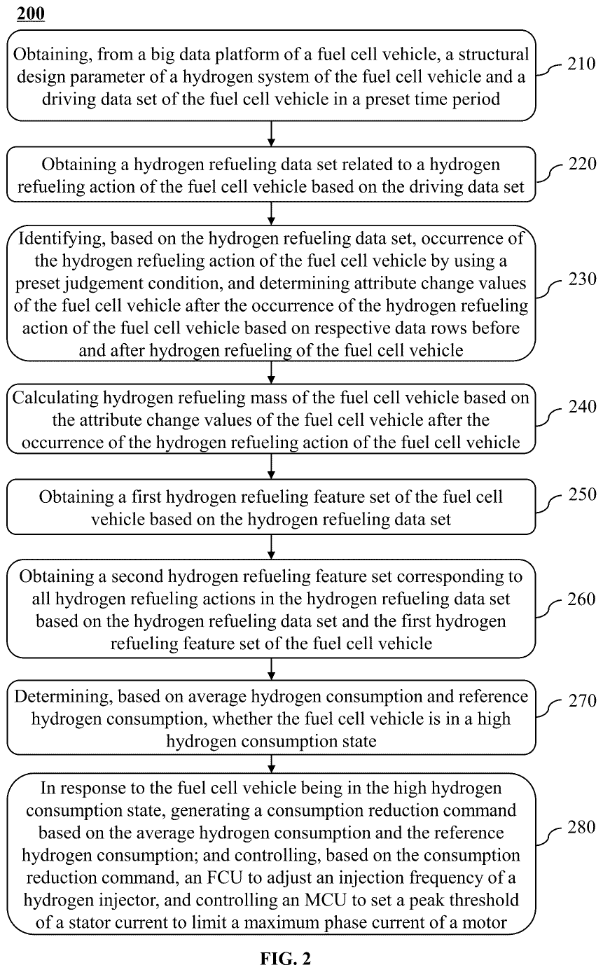

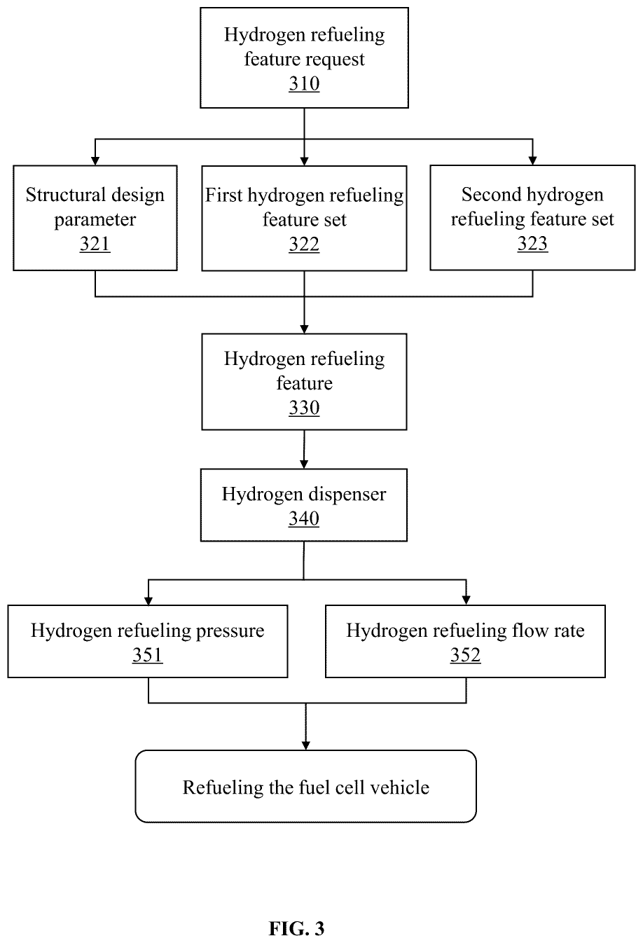

More descriptions regarding the above modules may be found in FIG. 2 to FIG. 3 and related descriptions thereof.

FIG. 2 is a flowchart illustrating an exemplary method for controlling a hydrogen refueling action of a fuel cell vehicle according to some embodiments of the present disclosure. As shown in FIG. 2, a process 200 includes operations 210-280. In some embodiments, the process 200 may be performed by the vehicle control unit 110.

In 210, obtaining, from a big data platform of a fuel cell vehicle, a structural design parameter of a hydrogen system of the fuel cell vehicle and a driving data set of the fuel cell vehicle in a preset time period.

The fuel cell vehicle refers to an electric vehicle that uses a fuel cell system as a main power source and drives a motor by generating electricity through a hydrogen-oxygen chemical reaction.

The big data platform refers to a cloud-based or on-board computing system for collecting, storing, processing, and analyzing operation data of the fuel cell vehicle. For example, the big data platform includes a manufacturer database, a remote monitoring platform of an automobile manufacturer, a hydrogen energy vehicle data management center established by a government or a third-party institution, or the like.

The hydrogen system refers to a system related to hydrogen storage, supply, and safety in the fuel cell vehicle. For example, the hydrogen system includes hydrogen storage tanks, a hydrogen injector, a pressure reducing valve, a leak detection sensor, or the like.

The structural design parameter refers to a key parameter that describes physical characteristics of the hydrogen system.

In some embodiments, the structural design parameter may include at least one of a count of hydrogen storage tanks, a nominal water volume of each of the hydrogen storage tanks, and a nominal operating pressure of each of the hydrogen storage tanks.

In some embodiments, the structural design parameter may be determined by a vehicle manufacturer and stored in the big data platform, and the vehicle control unit may communicate with the big data platform and obtain the structural design parameter from the big data platform.

The preset time period refers to a time range preset by the system for monitoring and analyzing driving data of the fuel cell vehicle.

In some embodiments, the preset time period may be set by the vehicle control unit according to requirements. For example, the preset time period may be 10 minutes, 15 minutes, or the like.

In some embodiments, a duration of the preset time period is related to predicted hydrogen consumption of the fuel cell vehicle in a future time period and a remaining hydrogen quantity of each of the hydrogen storage tanks. For example, a smaller difference between the remaining hydrogen quantity and the predicted hydrogen consumption corresponds to a smaller duration of the preset time period. Merely by way of example, when the difference between the remaining hydrogen quantity and the predicted hydrogen consumption is less than a first preset threshold, the fuel cell vehicle is in a fuel shortage state. At this time, the vehicle control unit automatically shortens the preset time period to increase a collection frequency of the remaining hydrogen quantity and an analysis frequency of the predicted hydrogen consumption. The first preset threshold may be a system preset value, a manually preset value, or the like.

More descriptions regarding the predicted hydrogen consumption and the remaining hydrogen quantity may be found in related descriptions below.

In some embodiments of the present disclosure, by correlating the duration of the preset time period with the predicted hydrogen consumption and the remaining hydrogen quantity, an intelligent control strategy for dynamically adjusting a monitoring frequency is achieved. In the fuel shortage state, the vehicle control unit can automatically shorten the preset time period and increase data collection and analysis frequencies, thereby more accurately capturing a hydrogen consumption change trend and avoiding a vehicle breakdown risk caused by fuel exhaustion.

The driving data set refers to an operation data set recorded by the vehicle control unit in the preset time period. For example, the driving data set may include a vehicle speed, data related to occurrence of the hydrogen refueling action of the fuel cell vehicle, pressure data of the hydrogen storage tanks, temperature data of the hydrogen storage tanks, or the like. For example, the data related to the occurrence of the hydrogen refueling action of the fuel cell vehicle may include at least one of an information sending time, a cumulative mileage, a maximum temperature in the hydrogen system, and a maximum hydrogen pressure. More descriptions may be found in related descriptions below.

In some embodiments, the driving data set may be obtained by an on-board sensor and stored in the big data platform, and the vehicle control unit may communicate with the big data platform and obtain the driving data set from the big data platform. The on-board sensor may include a pressure sensor, a temperature sensor, an inertial measurement unit, or the like.

In 220, obtaining a hydrogen refueling data set related to a hydrogen refueling action of the fuel cell vehicle based on the driving data set.

The hydrogen refueling action refers to an action of replenishing hydrogen for the fuel cell vehicle at a hydrogen refueling station.

The hydrogen refueling data set refers to a set of data related to the hydrogen refueling action.

In some embodiments, the hydrogen refueling data set may include at least one of an information sending time, a cumulative mileage, a maximum temperature in the hydrogen system, and a maximum hydrogen pressure. The information sending time refers to a time when the fuel cell vehicle sends data related to the hydrogen refueling action to the big data platform during a hydrogen refueling process. The cumulative mileage refers to a total driving mileage of the fuel cell vehicle from being put into use until the information sending time. The maximum temperature in the hydrogen system refers to a maximum temperature of the hydrogen system of the fuel cell vehicle during the hydrogen refueling process. The maximum hydrogen pressure refers to a maximum pressure of hydrogen in the hydrogen storage tanks of the fuel cell vehicle during the hydrogen refueling process.

In some embodiments, the hydrogen refueling data set may further include the pressure data and the temperature data of each of the hydrogen storage tanks, or the like.

In some embodiments, the vehicle control unit may determine at least one type of data related to the hydrogen refueling action of the fuel cell vehicle in the driving data set as the hydrogen refueling data set related to the hydrogen refueling action of the fuel cell vehicle.

In some embodiments, the vehicle control unit may obtain n rows of data, which are arranged in a sequence of sending times, in the driving data set involving the hydrogen refueling action of the fuel cell vehicle as the hydrogen refueling data set. In a row m of data in the hydrogen refueling data set, an information sending time is represented as Time_m, a cumulative mileage is represented as S_m, a maximum temperature in the hydrogen system is represented as Temp_m, and a maximum hydrogen pressure is represented as P_m, where values of Time_m, S_m, Temp_m, and P_m are not null sets and are not zero. In a row m−1 of data in the hydrogen refueling data set, an information sending time is represented as Time_m−1, a cumulative mileage is represented as S_m−1, a maximum temperature in the hydrogen system is represented as Temp_m−1, and a maximum hydrogen pressure is represented as P_m−1.

In some embodiments of the present disclosure, by strictly defining composition rules and screening conditions for the hydrogen refueling data set, data integrity and logical coherence are ensured, providing a reliable foundation for precise analysis of the hydrogen refueling action of the fuel cell vehicle.

In 230, identifying, based on the hydrogen refueling data set, occurrence of the hydrogen refueling action of the fuel cell vehicle by using a preset judgement condition, and determining attribute change values of the fuel cell vehicle after the occurrence of the hydrogen refueling action of the fuel cell vehicle based on respective data rows before and after hydrogen refueling of the fuel cell vehicle.

The preset judgment condition refers to a computer logic rule for identifying whether the hydrogen refueling action occurs to the fuel cell vehicle.

In some embodiments, the preset judgment condition may be that a difference between maximum hydrogen pressures in the hydrogen storage tanks of the fuel cell vehicle before and after the hydrogen refueling is greater than a preset pressure change threshold. The preset pressure change threshold may be a system default value, a system preset value, or a manually preset value, or the like.

The data row refers to a recorded data set.

In some embodiments, the data row may include an information sending time, a cumulative mileage, a maximum temperature in the hydrogen system, a maximum hydrogen pressure, or the like.

In some embodiments, the vehicle control unit may determine the row m of data in the hydrogen refueling data set as a corresponding data row after the hydrogen refueling of the fuel cell vehicle.

In some embodiments, if values of Time_m−1, S_m−1, Temp_m−1, and P_m−1 of row m−1 of data in the hydrogen refueling data set are not null sets and are not zero, the vehicle control unit determines the row m−1 of data as a data row before the hydrogen refueling of the fuel cell vehicle. If the values of Time_m−1, S_m−1, Temp_m−1, and P_m−1 of the row m−1 of data in the hydrogen refueling data set are null sets or are zero, the vehicle control unit traces forward a valid data row according to the sending time until the valid data row is found, the valid data row is represented as a row m-a, and a is in a range of [1, 2, . . . , m−1], and the vehicle control unit determines row m-a of data as the data row before the hydrogen refueling of the fuel cell vehicle. In the row m-a, an information sending time is Time_m-a, a cumulative mileage is S_m-a, a maximum temperature in the hydrogen system is Temp_m-a, and a maximum hydrogen pressure is P_m-a.

The valid data row refers to a data row in the hydrogen refueling data set where each value is not null set and is not zero.

When the hydrogen refueling action occurs for the first time in the hydrogen refueling data set, the count of hydrogen refueling operations is recorded as 1, and each subsequent hydrogen refueling action occurs, the count of hydrogen refueling operations is increased by 1.

In some embodiments of the present disclosure, by employing a strict mechanism of data validity verification, identification accuracy of the hydrogen refueling action is ensured. A verification rule of not null set and not zero is used to exclude interference from invalid data. A mechanism of forward tracing ensures data continuity. Even if original data has gaps, the forward tracing mechanism automatically corrects a reference row, thereby avoiding misjudgment caused by data anomalies. Meanwhile, the count of hydrogen refueling operations is precisely counted using a dynamic counting mechanism, providing a quantitative basis for frequency analysis of the hydrogen refueling action.

The attribute change value refers to a parameter change amount caused by the hydrogen refueling action. For example, the attribute change value may include a change amount in the information sending time, the cumulative mileage, the maximum temperature in the hydrogen system, the maximum hydrogen pressure, or the like.

In some embodiments, the vehicle control unit may determine the attribute change values of the fuel cell vehicle after the occurrence of the hydrogen refueling action by calculation based on the respective data rows before and after the hydrogen refueling of the fuel cell vehicle.

For example, the vehicle control unit obtains the attribute change values by obtaining differences between Time_m, S_m, Temp_m, and P_m in the row m of data and Time_m−1, S_m−1, Temp_m−1, and P_m−1 in the row m−1 of data, respectively.

In 240, calculating hydrogen refueling mass of the fuel cell vehicle based on the attribute change values of the fuel cell vehicle after the occurrence of the hydrogen refueling action of the fuel cell vehicle.

The hydrogen refueling mass refers to an increase in mass of hydrogen in the hydrogen storage tanks of the fuel cell vehicle during one hydrogen refueling action.

In some embodiments, the vehicle control unit may calculate the hydrogen refueling mass of the fuel cell vehicle based on the attribute change values of the fuel cell vehicle after the occurrence of the hydrogen refueling action of the fuel cell vehicle through an ideal gas state equation correction manner, a hydrogen density lookup table manner, or the like.

In some embodiments, the pressure of each of the hydrogen storage tanks before hydrogen refueling of the fuel cell vehicle is P_before, and P_before=P_m-a. The pressure of each of the hydrogen storage tanks after hydrogen refueling of the fuel cell vehicle is P_after, and P_after=P_m. The temperature of each of the hydrogen storage tanks before hydrogen refueling of the fuel cell vehicle is Temp_before, and Temp_before=Temp_m-a. The temperature of each of the hydrogen storage tanks after hydrogen refueling of the fuel cell vehicle is Temp_after, and Temp_after=Temp_m. The vehicle control unit may calculate hydrogen storage mass m_tank_before before the hydrogen refueling of the fuel cell vehicle based on the pressure P_before and the temperature Temp_before of each of the hydrogen storage tanks before the hydrogen refueling of the fuel cell vehicle through equation (1):

$$m\_tank \_before = \frac{P\_before \times V\_tank \times n\_tank \times {M}_{H 2}}{R \times Temp\_before} , \qquad ( 1 )$$

where V_tank is the nominal water volume of each of the hydrogen storage tanks, n_tank is the count of hydrogen storage tanks, M_{H2} is molar mass of hydrogen, and R is an ideal gas constant.

The vehicle control unit may calculate hydrogen storage mass m_tank_after after the hydrogen refueling of the fuel cell vehicle based on the pressure P_after and the temperature Temp_after of each of the hydrogen storage tanks after the hydrogen refueling of the fuel cell vehicle through equation (2)

$$m\_tank \_after = \frac{P\_after \times V\_tank \times n\_tank \times {M}_{H 2}}{R \times Temp\_after} . \qquad ( 2 )$$

The vehicle control unit may determine hydrogen refueling mass m_tank_addmass of the fuel cell vehicle based on the hydrogen storage mass after the hydrogen refueling of the fuel cell vehicle and the hydrogen storage mass before the hydrogen refueling of the fuel cell vehicle through equation (3):

$$m\_tank \_addmass = m\_tank \_after - m\_tank \_before . \qquad ( 3 )$$

In some embodiments of the present disclosure, by precisely calculating a difference between the hydrogen storage mass before the hydrogen refueling and the hydrogen storage mass after the hydrogen refueling, direct quantitative evaluation of the hydrogen refueling mass is achieved.

In 250, obtaining a first hydrogen refueling feature set of the fuel cell vehicle based on the hydrogen refueling data set.

The first hydrogen refueling feature set refers to a set of physical quantity features extracted from the hydrogen refueling process of the fuel cell vehicle.

In some embodiments, the first hydrogen refueling feature set includes at least one of a pressure of each of the hydrogen storage tanks before hydrogen refueling of the fuel cell vehicle, a pressure of each of the hydrogen storage tanks after hydrogen refueling of the fuel cell vehicle, a temperature of each of the hydrogen storage tanks before hydrogen refueling of the fuel cell vehicle, and a temperature of each of the hydrogen storage tanks after hydrogen refueling of the fuel cell vehicle.

In some embodiments, the vehicle control unit may determine the occurrence of the hydrogen refueling action of the fuel cell vehicle by using a preset judgement condition, extract the pressure data and the temperature data of each of the hydrogen storage tanks of the fuel cell vehicle before and after the hydrogen refueling, and use the pressure data and the temperature data as the first hydrogen refueling feature set of the fuel cell vehicle.

In some embodiments, in response to the first hydrogen refueling feature set satisfying an overpressure condition, the vehicle control unit generates a mode switching command. The vehicle control unit forces the fuel cell vehicle to switch to a limp mode based on the mode switching command.

The overpressure condition refers to a situation where a pressure of each of the hydrogen storage tanks exceeds a preset pressure threshold after any hydrogen refueling in the first hydrogen refueling feature set. In some embodiments, the preset pressure threshold may be set as the nominal operating pressure of each of the hydrogen storage tanks. In some embodiments, the preset pressure threshold may be set as a percentage of the nominal operating pressure of each of the hydrogen storage tanks. For example, the preset pressure threshold is 90%, 110%, or 130% of the nominal operating pressure of each of the hydrogen storage tanks, etc.

The mode switching command refers to a command for forcibly switching the fuel cell vehicle to a safe driving mode. The safe driving mode is a restricted operation state that the fuel cell vehicle automatically or forcibly switches to via a remote command when an abnormal condition (e.g., overpressure of the hydrogen storage tank) is detected.

In some embodiments, the vehicle control unit monitors the pressure of each of the hydrogen storage tanks of the fuel cell vehicle after the hydrogen refueling in real time. In response to determining that the pressure of each of the hydrogen storage tanks of the fuel cell vehicle after the hydrogen refueling exceeds the preset pressure threshold, the vehicle control unit triggers the mode switching command.

The limp mode refers to a safe driving mode of the fuel cell vehicle.

In some embodiments, the limp mode is that the fuel cell vehicle is forced to be limited to minimum speed driving.

In some embodiments of the present disclosure, by analyzing the first hydrogen refueling feature set to identify the overpressure condition of each of the hydrogen storage tanks, the vehicle control unit actively triggers the limp mode, forcing the fuel cell vehicle to be limited to minimum speed driving, thereby avoiding sudden safety accidents (e.g., hydrogen injection or explosion) caused by sustained high pressure.

In 260, obtaining a second hydrogen refueling feature set corresponding to all hydrogen refueling actions in the hydrogen refueling data set based on the hydrogen refueling data set and the first hydrogen refueling feature set of the fuel cell vehicle.

The second hydrogen refueling feature set refers to a dynamic feature set related to the hydrogen refueling action extracted from the hydrogen refueling data set of the fuel cell vehicle.

In some embodiments, the second hydrogen refueling feature set may include at least one of a hydrogen refueling interval distance, a hydrogen refueling interval time, a count of hydrogen refueling operations, the hydrogen refueling mass, and average hydrogen consumption.

In some embodiments, the vehicle control unit may obtain the second hydrogen refueling feature set corresponding to all hydrogen refueling actions in the hydrogen refueling data set based on the hydrogen refueling data set and the first hydrogen refueling feature set of the fuel cell vehicle.

In some embodiments, the vehicle control unit determines the hydrogen refueling interval distance based on a cumulative mileage of the fuel cell vehicle when two adjacent hydrogen refueling actions occur through equation (4):

$$H 2 \_add \_int \_distance = {S\_m}^{′} - S\_m , \qquad ( 4 )$$

where H2_add_int_distance represents the hydrogen refueling interval distance, S_m′ represents a cumulative mileage of the fuel cell vehicle when a next hydrogen refueling action occurs, and S_m represents a cumulative mileage of the fuel cell vehicle when a current hydrogen refueling action occurs.

The vehicle control unit determines the hydrogen refueling interval time based on information sending times of the fuel cell vehicle when the two adjacent hydrogen refueling actions occur through equation (5):

$$H2\_add \_int \_time = {Time\_m}^{′} - Time\_m , \qquad ( 5 )$$

where H2_add_int_time represents the hydrogen refueling interval time, Time_m′ represents an information sending time of the fuel cell vehicle when the next hydrogen refueling action occurs, and Time_m represents an information sending time of the fuel cell vehicle when the current hydrogen refueling action occurs.

The vehicle control unit determines the average hydrogen consumption based on hydrogen mass consumed between the current hydrogen refueling action and the next hydrogen refueling action of the fuel cell vehicle and the hydrogen refueling interval distance through equation (6):

$$H2\_comp \_rate = \frac{m\_tank \_mass \_comp}{H2\_add \_int \_distance} , \qquad ( 6 )$$

where H2_comp_rate represents the average hydrogen consumption, m_tank_mass_comp represents the hydrogen mass consumed between the current hydrogen refueling action and the next hydrogen refueling action, a value of the hydrogen mass is equal to hydrogen storage mass of the fuel cell vehicle after hydrogen refueling for the current hydrogen refueling action minus hydrogen storage mass of the fuel cell vehicle before hydrogen refueling for the next hydrogen refueling action; and H2_add_int_distance represents the hydrogen refueling interval distance between the current hydrogen refueling action and the next hydrogen refueling action.

In some embodiments of the present disclosure, by accurately calculating the second hydrogen refueling feature set such as the hydrogen refueling interval distance, the hydrogen refueling interval time, and the average hydrogen consumption, dynamic monitoring and energy efficiency evaluation of the hydrogen refueling action of the fuel cell vehicle are achieved, effectively enhancing the intelligence level of a hydrogen energy management system.

In 270, determining, based on average hydrogen consumption and reference hydrogen consumption, whether the fuel cell vehicle is in a high hydrogen consumption state.

The reference hydrogen consumption refers to a reference value for evaluating hydrogen energy consumption efficiency of the fuel cell vehicle.

In some embodiments, the vehicle control unit may use an average of average hydrogen consumptions generated by a plurality of reference vehicles between a current hydrogen refueling action and a next hydrogen refueling action as the reference hydrogen consumption. The reference vehicles refer to vehicles of a same type as the fuel cell vehicle. For example, the reference vehicles include passenger vehicles, commercial vehicles, or the like. The passenger vehicles may include sedans, sports cars, or the like. The commercial vehicles may include heavy-duty trucks (tractors), light logistics vehicles, city buses, long-distance coaches, sanitation vehicles, or the like.

The high hydrogen consumption state refers to a state of high hydrogen consumption.

In some embodiments, in response to a difference between an average of a plurality of average hydrogen consumptions in the second hydrogen refueling feature set and the reference hydrogen consumption being greater than a preset hydrogen consumption threshold, the vehicle control unit determines that the fuel cell vehicle is in the high hydrogen consumption state. The plurality of average hydrogen consumptions refer to average hydrogen consumptions generated by a plurality of hydrogen refueling actions of the fuel cell vehicle. The preset hydrogen consumption threshold may be a system preset value, a manually preset value, or the like.

In 280, in response to the fuel cell vehicle being in the high hydrogen consumption state, generating a consumption reduction command based on the average hydrogen consumption and the reference hydrogen consumption; and controlling, based on the consumption reduction command, an FCU to adjust an injection frequency of a hydrogen injector, and controlling an MCU to set a peak threshold of a stator current to limit a maximum phase current of a motor.

The consumption reduction command refers to a command for adjusting a hydrogen supply strategy and a motor output strategy. For example, the consumption reduction command includes the injection frequency of the hydrogen injector, the peak threshold of the stator current, or the like.

In some embodiments, in response to the fuel cell vehicle being in the high hydrogen consumption state, the vehicle control unit may generate the consumption reduction command by matching a preset table based on the average hydrogen consumption and the reference hydrogen consumption. The preset table may include a corresponding relationship between a plurality of combinations of the average hydrogen consumption and the reference hydrogen consumption and a plurality of combinations of the injection frequency and the peak threshold. In some embodiments, the preset table may be set by a technician based on experience.

The FCU refers to a device for monitoring and controlling operation of the fuel cell system.

The hydrogen injector refers to an electromagnetic valve or an electronically controlled injection device for precisely supplying hydrogen to the fuel cell system.

The injection frequency refers to a count of injections of the hydrogen injector per unit time.

In some embodiments, based on the consumption reduction command, the vehicle control unit controls the FCU to reduce the injection frequency of the hydrogen injector to reduce an amount of hydrogen entering an anode side of a fuel cell stack from a high-pressure pipeline, thereby reducing an electric power of the fuel cell stack.

The MCU refers to a device for controlling operation of the motor. For example, the MCU may control a motor torque, a motor speed, and a motor current output.

The stator current refers to an alternating current that drives a stator winding of the motor.

The maximum phase current refers to a maximum current value allowed for a single-phase winding of the motor.

In some embodiments, based on the consumption reduction command, the vehicle control unit controls the MCU to set the peak threshold of the stator current. During operation of the motor, in response to detecting that an actual phase current of the motor exceeds the peak threshold, the MCU performs peak clipping on the phase current through current closed-loop control, thereby limiting the maximum phase current of the motor.

In some embodiments of the present disclosure, by obtaining the structural design parameter of the hydrogen system and the driving data set of the fuel cell vehicle in real time through the big data platform, combining identification of the hydrogen refueling action and attribute change value analysis, and accurately calculating the hydrogen refueling mass and extracting the first hydrogen refueling feature set and the second hydrogen refueling feature set, whether the fuel cell vehicle is in the high hydrogen consumption state is intelligently determined based on dynamic comparison between the average hydrogen consumption and the reference hydrogen consumption. In response to the fuel cell vehicle being in the high hydrogen consumption state, the vehicle control unit automatically generates the consumption reduction command and coordinately controls the FCU to adjust the injection frequency of the hydrogen injector and the MCU to limit the maximum phase current of the motor, forming a mechanism of closed-loop energy consumption optimization with hydrogen-electricity linkage. Thus, under the premise of ensuring dynamic performance, hydrogen consumption of the fuel cell vehicle in the high hydrogen consumption state is effectively reduced by real-time intervention in injection strategy and motor output, and overall energy efficiency and economy of the fuel cell system are improved.

In some embodiments, in response to the fuel cell vehicle being in the high hydrogen consumption state, the vehicle control unit constructs a hydrogen consumption reference library of the fuel cell vehicle based on a plurality of historical second hydrogen refueling feature sets of the fuel cell vehicle, historical ambient temperatures, and historical road condition information; determines a remaining hydrogen quantity of each of the hydrogen storage tanks based on the pressure data and the temperature data of each of the hydrogen storage tanks; determines predicted hydrogen consumption of the fuel cell vehicle in a future time period based on road condition information and ambient temperatures through the hydrogen consumption reference library; determines an injection frequency sequence and a peak threshold sequence based on the road condition information, the remaining hydrogen quantity, and the predicted hydrogen consumption; generates a frequency control command and a peak control command based on the injection frequency sequence and the peak threshold sequence; controls the FCU to adjust the injection frequency of the hydrogen injector for at least one future moment based on the frequency control command; and controls the MCU to set the peak threshold of the stator current for the at least one future moment based on the peak control command.

The historical second hydrogen refueling feature set refers to a second hydrogen refueling feature set of the fuel cell vehicle in a historical time period. The historical time period may include one month, one quarter, one year, etc.

The historical ambient temperature refers to an ambient temperature corresponding to the historical time period in the historical second hydrogen refueling feature set.

The historical road condition information refers to road condition information corresponding to the historical time period in the historical second hydrogen refueling feature set.

More descriptions regarding the road condition information may be found in related descriptions below.

The hydrogen consumption reference library includes a plurality of sets of corresponding relationships among the ambient temperature, the road condition information, and the average hydrogen consumption.

In some embodiments, the vehicle control unit performs clustering analysis on the plurality of historical second hydrogen refueling feature sets of the fuel cell vehicle to obtain the hydrogen consumption reference library of the fuel cell vehicle. For example, the vehicle control unit constructs clustering vectors based on the historical ambient temperatures and the historical road condition information. The vehicle control unit performs clustering analysis on the clustering vectors to obtain a plurality of clustering clusters. For each of the plurality of clustering clusters, the vehicle control unit counts a historical ambient temperature range and a historical road condition information range of all clustering vectors in one clustering cluster. The vehicle control unit uses the historical ambient temperature range, the historical road condition information range, and a mean value of labels corresponding to all the clustering vectors in the clustering cluster as a piece of data in the hydrogen consumption reference library.

The label corresponding to the clustering vector may be average hydrogen consumption in a subsequent time period after historical moments corresponding to the historical ambient temperatures and the historical road condition information in the plurality of historical second hydrogen refueling feature sets. The subsequent time period may be 5 minutes, 10 minutes, or the like.

In some embodiments, the vehicle control unit may determine the remaining hydrogen quantity of each of the hydrogen storage tanks based on the pressure data and the temperature data of each of the hydrogen storage tanks through an ideal gas state equation.

The road condition information refers to traffic state data of road segments on a driving route of the fuel cell vehicle. In some embodiments, the road condition information may include congestion degrees of the road segments and a proportion of road segments with different congestion degrees to a total length of the road segments.

The future time period refers to a time period after the preset time period, such as 5 minutes, 10 minutes, or the like.

The predicted hydrogen consumption refers to predicted average hydrogen consumption of the fuel cell vehicle in the future time period.

In some embodiments, the vehicle control unit may match corresponding average hydrogen consumption through the hydrogen consumption reference library based on road condition information and an ambient temperature at a current moment, and use the corresponding average hydrogen consumption as the predicted hydrogen consumption.

The injection frequency sequence refers to injection frequencies at a plurality of moments in the future time period.

The peak threshold sequence refers to peak thresholds at a plurality of moments in the future time period.

In some embodiments, the vehicle control unit may determine the injection frequency sequence and the peak threshold sequence by matching a first vector database based on the road condition information, the remaining hydrogen quantity, and the predicted hydrogen consumption. For example, the vehicle control unit constructs a first target vector based on current road condition information, a current remaining hydrogen quantity, and current predicted hydrogen consumption. The vehicle control unit performs retrieval in the first vector database based on the first target vector to obtain a first feature vector with a highest similarity to the first target vector. The vehicle control unit uses a first label corresponding to the first feature vector as an injection frequency sequence and a peak threshold sequence corresponding to the first target vector.

The first vector database includes a plurality of first feature vectors and first labels corresponding to the plurality of first feature vectors. The first feature vectors are constructed based on the historical road condition information, the historical remaining hydrogen quantity, and the historical predicted hydrogen consumption. In some embodiments, the vehicle control unit may use a historical injection frequency sequence and a historical peak threshold sequence that satisfy a first preset condition among a plurality of historical injection frequency sequences and a plurality of historical peak threshold sequences corresponding to the first feature vectors as the first label corresponding to the first feature vector. The first preset condition is that: in a subsequent time period after a moment corresponding to the first feature vector, a driving speed fluctuation of the fuel cell vehicle is minimum and hydrogen consumption is lowest. The subsequent time period may be 5 minutes, 10 minutes, or the like.

The frequency control command refers to controlling the injection frequencies at the plurality of moments in the future time period.

In some embodiments, the vehicle control unit compares a plurality of predicted injection frequencies in the injection frequency sequence with a current injection frequency. In response to determining that a predicted injection frequency is greater than the current injection frequency, the vehicle control unit generates a frequency increase command. In response to determining that the predicted injection frequency is less than the current injection frequency, the vehicle control unit generates a frequency decrease command.

The peak control command refers to controlling the peak thresholds at the plurality of moments in the future time period.

In some embodiments, the vehicle control unit compares a plurality of predicted peak thresholds in the peak threshold sequence with a present current. In response to determining that the present current is greater than or equal to a predicted peak threshold multiplied by a warning coefficient (e.g., 0.9), the vehicle control unit generates a peak pre-reduction command. In response to determining that the present current is less than the predicted peak threshold multiplied by a safety coefficient (e.g., 0.8), the vehicle control unit generates a peak slow-increase command.

In some embodiments, the vehicle control unit controls the FCU to increase the injection frequency of the hydrogen injector at a future moment corresponding to the frequency increase command in the frequency control command based on the frequency increase command. The vehicle control unit controls the FCU to reduce the injection frequency of the hydrogen injector at a future moment corresponding to the frequency decrease command in the frequency control command based on the frequency decrease command.

In some embodiments, the vehicle control unit controls the MCU to reduce the peak threshold of the stator current at a future moment corresponding to the peak pre-reduction command in the peak control command based on the peak pre-reduction command. The vehicle control unit controls the MCU to increase the peak threshold of the stator current at a future moment corresponding to the peak slow-increase command in the peak control command based on the peak slow-increase command.

In some embodiments of the present disclosure, forward-looking predictive control combining the road condition information and the remaining hydrogen quantity achieves refined energy management based on future driving requirements. The forward-looking predictive control effectively reduces the impact of hydrogen consumption fluctuation on power output, optimizes hydrogen energy utilization, and significantly improves the driving range and economy of the fuel cell vehicle.

In some embodiments, when the remaining hydrogen quantity is less than a preset hydrogen quantity threshold, the vehicle control unit determines a target hydrogen refueling station based on a mean value of hydrogen refueling interval distances in the plurality of historical second hydrogen refueling feature sets, the road condition information, and the remaining hydrogen quantity. The vehicle control unit generates a navigation command to guide the fuel cell vehicle to the target hydrogen refueling station.

The preset hydrogen quantity threshold may be a system preset value, a manually preset value, or the like.

The target hydrogen refueling station refers to an optimal hydrogen refueling station for hydrogen supply when the remaining hydrogen quantity of the fuel cell vehicle is less than the preset hydrogen quantity threshold.

In some embodiments, when the remaining hydrogen quantity is less than the preset hydrogen quantity threshold, the vehicle control unit obtains at least one hydrogen refueling path between at least one hydrogen refueling station satisfying a second preset condition and a current fuel cell vehicle, and road condition information of the at least one hydrogen refueling path. The vehicle control unit uses a hydrogen refueling station satisfying a third preset condition among the at least one hydrogen refueling station as the target hydrogen refueling station based on a mean value of hydrogen refueling interval distances in the plurality of historical second hydrogen refueling feature sets and the road condition information of the at least one hydrogen refueling path.

The second preset condition may be that a distance between the hydrogen refueling station and the fuel cell vehicle is less than a preset distance threshold. The third preset condition may be that a weighted sum of a difference between a path length of a hydrogen refueling path and the mean value of the plurality of hydrogen refueling interval distances, and a congestion degree in the road condition information is minimum. For example, the vehicle control unit calculates a difference between a distance of the hydrogen refueling path and the mean value of the plurality of hydrogen refueling interval distances. The vehicle control unit performs a normalization process on the difference and the congestion degree in the road condition information to obtain the weighted sum. Merely by way of example, assuming that a path of the hydrogen refueling path is L1, a mean value of the hydrogen refueling interval distances is L2, and the road condition information is (traffic flow A1, k1; traffic flow A2, k2), the weighted sum is expressed as: L′+A1′*k1+A2′*k2. L′ is a weight coefficient of the difference between the path length of the hydrogen refueling path and the mean value of the plurality of hydrogen refueling interval distances. A1′ is a weight coefficient of a congestion degree of A1. A2′ is a weight coefficient of a congestion degree of A2.

The navigation command refers to a dynamic path driving command for guiding the fuel cell vehicle to reach the target hydrogen refueling station.

In some embodiments, the vehicle control unit guides the fuel cell vehicle to the target hydrogen refueling station based on the navigation command.

In some embodiments of the present disclosure, dynamic fusion of the mean value of the hydrogen refueling interval distances in the historical second hydrogen refueling feature sets, the road condition information, and the remaining hydrogen quantity intelligently matches the target hydrogen refueling station. The dynamic fusion effectively avoids the risk of hydrogen exhaustion caused by subjective estimation deviation of a driver, and ensures seamless connection of the fuel cell vehicle at a key node of hydrogen energy replenishment, thereby guaranteeing driving range continuity and improving driving safety.

It should be noted that the above descriptions regarding the process 200 are merely for illustration and explanation, and do not limit the applicable scope of the present disclosure. For those skilled in the art, various modifications and changes to the process 200 may be made under the guidance of the present disclosure. However, these modifications and changes are still within the scope of the present disclosure.

FIG. 3 is a schematic diagram illustrating an exemplary process of determining hydrogen refueling of a fuel cell vehicle according to some embodiments of the present disclosure.

In some embodiments, as shown in FIG. 3, in response to receiving a hydrogen refueling feature request 310, a hydrogen refueling station control unit generates a hydrogen refueling feature 330 of the fuel cell vehicle based on a structural design parameter 321, a first hydrogen refueling feature set 322, and a second hydrogen refueling feature set 323. The hydrogen refueling station control unit sends the hydrogen refueling feature 330 to a hydrogen dispenser 340. The hydrogen dispenser 340 generates a hydrogen refueling pressure 351 and a hydrogen refueling flow rate 352 based on the hydrogen refueling feature 330. The hydrogen dispenser 340 refuels the fuel cell vehicle based on the hydrogen refueling pressure 351 and the hydrogen refueling flow rate 352.

More descriptions regarding the first hydrogen refueling feature set and the second hydrogen refueling feature set may be found in FIG. 2 and the related descriptions thereof.

The hydrogen refueling feature request refers to a data request sent by the hydrogen dispenser to a big data platform for obtaining a hydrogen refueling feature of the fuel cell vehicle.

The hydrogen dispenser refers to a device for refueling hydrogen to the fuel cell vehicle.

The hydrogen refueling feature refers to a parameter index for guiding a hydrogen refueling process of the fuel cell vehicle.

In some embodiments, the hydrogen refueling feature may include a nominal water volume of each of hydrogen storage tanks, a count of hydrogen storage tanks, a pressure distribution after historical hydrogen refueling, a most recent hydrogen refueling interval distance, or the like. The pressure distribution refers to pressures of each of the hydrogen storage tanks of the fuel cell vehicle after a plurality of hydrogen refueling operations.

In some embodiments, the hydrogen refueling station control unit may obtain the nominal water volume of each of the hydrogen storage tanks and the count of hydrogen storage tanks based on the structural design parameter. The hydrogen refueling station control unit may obtain the pressure distribution after the historical hydrogen refueling based on a plurality of historical first hydrogen refueling feature sets. The hydrogen refueling station control unit may obtain the most recent hydrogen refueling interval distance based on historical second hydrogen refueling feature sets.

In some embodiments, the hydrogen dispenser may generate a hydrogen refueling pressure and a hydrogen refueling flow rate based on the hydrogen refueling feature by matching a second vector database. For example, the hydrogen dispenser constructs a second target vector based on a current hydrogen refueling feature. The hydrogen dispenser performs retrieval in the second vector database based on the second target vector to obtain a second feature vector with a highest similarity to the second target vector. The hydrogen dispenser uses a second label corresponding to the second feature vector as the hydrogen refueling pressure and the hydrogen refueling flow rate corresponding to the second target vector.

The second vector database includes a plurality of second feature vectors and second labels corresponding to the plurality of second feature vectors. The second feature vectors are constructed based on historical hydrogen refueling features. In some embodiments, the hydrogen dispenser may use a historical hydrogen refueling pressure and a historical hydrogen refueling flow rate satisfying a fourth preset condition as the second label corresponding to the second feature vector. The fourth preset condition is that a filling ratio is the highest among a plurality of historical hydrogen refueling pressures and a plurality of historical hydrogen refueling flow rates corresponding to the second feature vector. The filling ratio refers to a percentage of an actual amount of hydrogen refueled to a rated capacity of each of the hydrogen storage tanks of the fuel cell vehicle.

In some embodiments of the present disclosure, a personalized hydrogen refueling feature for the fuel cell vehicle is generated based on the first hydrogen refueling feature set and the second hydrogen refueling feature set of the fuel cell vehicle. The hydrogen dispenser generates an optimal hydrogen refueling pressure and an optimal hydrogen refueling flow rate based on the hydrogen refueling feature. The hydrogen dispenser significantly improves hydrogen refueling efficiency while ensuring safety of hydrogen storage tanks. The hydrogen dispenser reduces unnecessary pressure fluctuations by matching historical hydrogen refueling patterns of the fuel cell vehicle, thereby extending the service life of the hydrogen dispenser.

In some embodiments, in response to receiving a hydrogen refueling state request, the hydrogen refueling station control unit determines a hydrogen refueling state of the fuel cell vehicle based on the first hydrogen refueling feature set and the second hydrogen refueling feature set. The hydrogen refueling station control unit sends the hydrogen refueling state to the hydrogen dispenser. The hydrogen dispenser determines whether to lock a hydrogen refueling nozzle based on the hydrogen refueling state.

The hydrogen refueling state request refers to a data request sent by the hydrogen dispenser to the big data platform for obtaining the hydrogen refueling state of the fuel cell vehicle.

The hydrogen refueling state refers to a description of a current operation state or fault status of the fuel cell vehicle.

In some embodiments, the hydrogen refueling state may include that the fuel cell vehicle is in a normal driving state, a hydrogen leakage state, a poor heat dissipation performance state, or the like.

In some embodiments, if a difference between physical consumption and fuel cell stack consumption is greater than a second preset threshold, the hydrogen refueling station control unit determines that the fuel cell vehicle is in the hydrogen leakage state. The second preset threshold may be a system preset value, a manually preset value, or the like.

The physical consumption refers to actual hydrogen mass consumed in each of the hydrogen storage tanks of the fuel cell vehicle between two hydrogen refueling actions. The hydrogen refueling station control unit may calculate a difference between hydrogen mass in the hydrogen storage tanks after previous hydrogen refueling of the fuel cell vehicle and hydrogen mass in the hydrogen storage tanks before current hydrogen refueling of the fuel cell vehicle based on the first hydrogen refueling feature set, and uses the difference as the physical consumption.

The fuel cell stack consumption refers to theoretical hydrogen consumption calculated by an FCU based on a power generation amount of a fuel cell stack between two hydrogen refueling actions.

In some embodiments, the hydrogen refueling station control unit calculates a difference between a temperature of each of the hydrogen storage tanks before most recent hydrogen refueling of the fuel cell vehicle and a temperature of each of the hydrogen storage tanks after the most recent hydrogen refueling of the fuel cell vehicle based on the first hydrogen refueling feature set, and uses the difference as a temperature rise of the most recent hydrogen refueling. The hydrogen refueling station control unit calculates an average temperature rise of a plurality of historical hydrogen refueling actions based on the second hydrogen refueling feature set. If a difference between the temperature rise of the most recent hydrogen refueling and the average temperature rise is greater than a third preset threshold, the hydrogen refueling station control unit determines that the fuel cell vehicle is in the poor heat dissipation performance state. The third preset threshold may be a system preset value, a manually preset value, or the like.

In some embodiments, if the difference between the physical consumption and the fuel cell stack consumption is less than or equal to the second preset threshold, and the difference between the temperature rise of the most recent hydrogen refueling and the average temperature rise is less than or equal to the third preset threshold, the hydrogen refueling station control unit determines that the fuel cell vehicle is in the normal driving state.

In some embodiments, if the fuel cell vehicle is in the hydrogen leakage state or the poor heat dissipation performance state, the hydrogen dispenser locks the hydrogen refueling nozzle.

In some embodiments of the present disclosure, the hydrogen refueling station control unit determines the hydrogen refueling state of the fuel cell vehicle in real time based on the first hydrogen refueling feature set and the second hydrogen refueling feature set. The hydrogen refueling station control unit links with the hydrogen dispenser to execute a physical blocking mechanism of locking the hydrogen refueling nozzle. The hydrogen refueling station control unit can accurately identify and intercept a fuel cell vehicle with a safety hazard, so that hydrogen supply to a high-risk fuel cell vehicle is completely cut off before the hydrogen refueling operation, thereby eliminating safety accidents caused by improper hydrogen refueling at the source and ensuring safety and reliability of the hydrogen refueling process.

In some embodiments, the vehicle control unit may draw and obtain hydrogen refueling action features of the fuel cell vehicle driving in a preset time period based on a hydrogen refueling data set, the first hydrogen refueling feature set, and the second hydrogen refueling feature set.

More descriptions regarding the hydrogen refueling data set and the preset time period may be found in FIG. 2 and the related descriptions thereof.

The hydrogen refueling action features refer to a quantitative index set extracted by analyzing the hydrogen refueling data set of the fuel cell vehicle. The hydrogen refueling action features may reflect a hydrogen refueling action pattern, a hydrogen energy use efficiency, and an operation characteristic of the fuel cell vehicle.

In some embodiments, the hydrogen refueling action features may provide a reference for analysis of hydrogen refueling patterns of the fuel cell vehicle, and planning and layout of geographical locations and hydrogen refueling capacities of hydrogen refueling stations in an urban cluster.

In some embodiments, the hydrogen refueling action features may include a distribution of hydrogen refueling interval distances.

The distribution of hydrogen refueling interval distances refers to a statistical distribution of driving distances of the fuel cell vehicle between two adjacent hydrogen refueling operations.

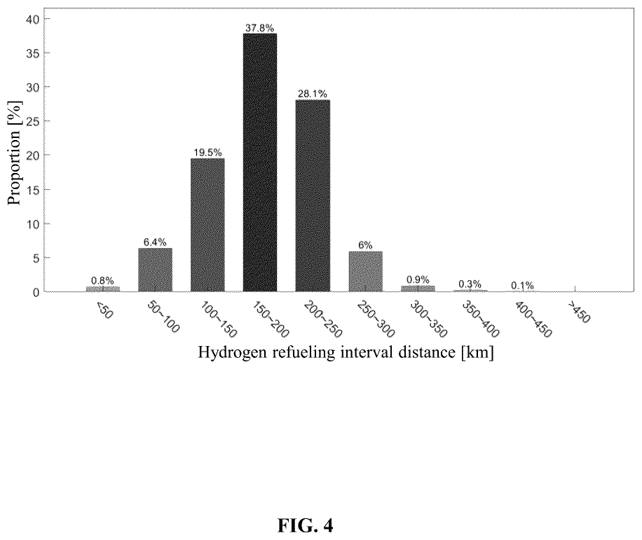

FIG. 4 is a schematic diagram illustrating a distribution of hydrogen refueling interval distances of a fuel cell vehicle according to some embodiments of the present disclosure. As shown in FIG. 4, the hydrogen refueling interval distances and proportions present a normal distribution pattern. For example, when a hydrogen refueling interval distance is small, the proportion is relatively low. As the hydrogen refueling interval distance increases, the proportion gradually rises and reaches a peak. When the hydrogen refueling interval distance continues to increase, the proportion shows a gradually decreasing trend. The proportion refers to a ratio of a count of fuel cell vehicles whose hydrogen refueling interval distances fall within a certain distance range to a total count of sample fuel cell vehicles.

In some embodiments, the hydrogen refueling action features may include a distribution of hydrogen refueling interval times.

The distribution of hydrogen refueling interval times refers to a statistical distribution of time intervals between two adjacent hydrogen refueling operations.

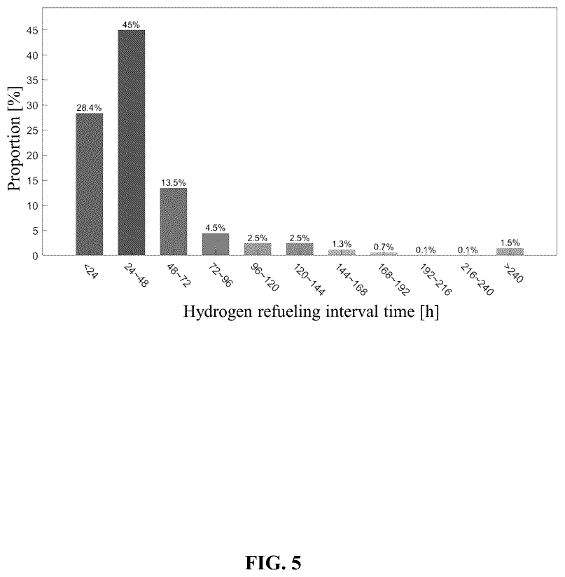

FIG. 5 is a schematic diagram illustrating a distribution of hydrogen refueling interval times of a fuel cell vehicle according to some embodiments of the present disclosure. As shown in FIG. 5, 28.4% of fuel cell vehicles have a hydrogen refueling interval time of less than 24 hours, 45% of fuel cell vehicles have a hydrogen refueling interval time between 24 hours and 48 hours, and 13.5% of fuel cell vehicles have a hydrogen refueling interval time between 48 hours and 72 hours. The three categories of fuel cell vehicles account for approximately 86.9% in total. However, 3.7% of hydrogen refueling actions still have a hydrogen refueling interval time exceeding 120 hours. This phenomenon may originate from some fuel cell vehicles being in a non-operating state on specific dates, or the fuel cell vehicles mainly relying on a power battery system during driving, which significantly extends the hydrogen refueling interval time.

In some embodiments, the hydrogen refueling action features may include a distribution of hydrogen refueling interval distances and hydrogen refueling interval times.

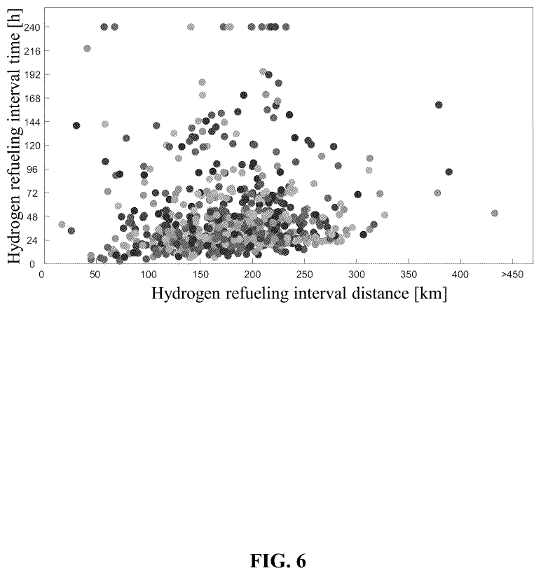

FIG. 6 is a schematic diagram illustrating a distribution of hydrogen refueling interval distances and hydrogen refueling interval times of a fuel cell vehicle according to some embodiments of the present disclosure. As shown in FIG. 6, the hydrogen refueling interval distances are mainly concentrated within 50-300 km, and the hydrogen refueling interval times are mostly distributed within a range of 0-96 hours. In addition, there are very few special cases where individual fuel cell vehicles have a hydrogen refueling interval distance exceeding 350 km, or a hydrogen refueling interval time being 192 hours or more.

In some embodiments, the hydrogen refueling action features may include a probability distribution of hydrogen refueling interval distances and hydrogen refueling interval times.

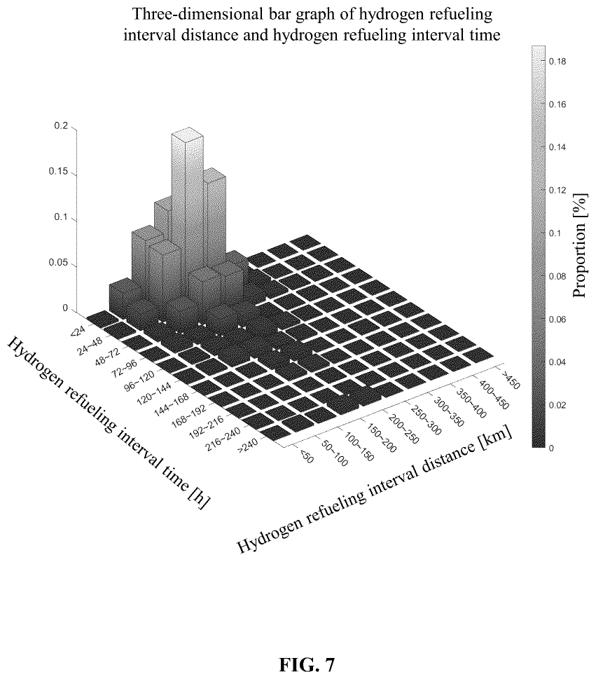

FIG. 7 is a schematic diagram illustrating a probability distribution of hydrogen refueling interval distances and hydrogen refueling interval times of a fuel cell vehicle according to some embodiments of the present disclosure. As shown in FIG. 7, the most intensive hydrogen refueling actions are concentrated in the interval distances of 150-200 km and the interval times of 24-48 hours, accounting for 18%, followed by hydrogen refueling actions concentrated in the interval distances of 200-250 km and the interval times of 24-48 hours, accounting for 14%. Combined with a pure hydrogen driving range of the fuel cell vehicle being 340 km, it can be found that a hydrogen refueling interval distance corresponding to a high-frequency range of the hydrogen refueling action of the fuel cell vehicle is approximately 50% of the pure hydrogen driving range. This phenomenon may be closely related to a layout density and a geographical distribution of local hydrogen refueling stations, reflecting a matching relationship between an actual hydrogen refueling demand of the fuel cell vehicle and an infrastructure supply during actual operation.

In some embodiments, the hydrogen refueling action features may include a distribution of a pressure of each of the hydrogen storage tanks before and after hydrogen refueling.

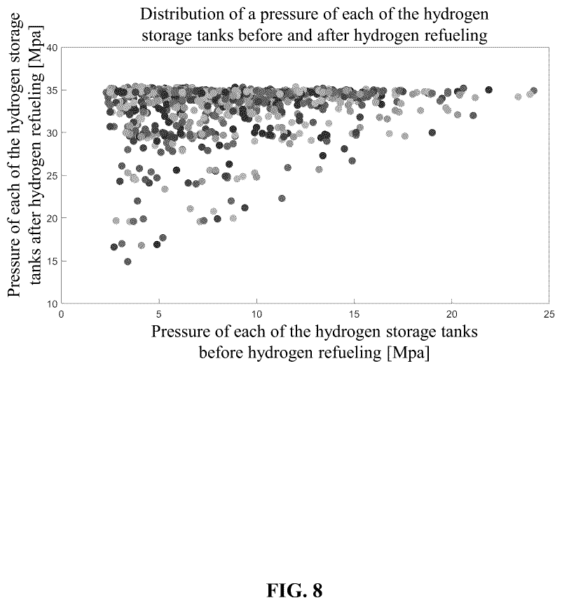

FIG. 8 is a schematic diagram illustrating a distribution of a pressure of each of hydrogen storage tanks before and after hydrogen refueling of a fuel cell vehicle according to some embodiments of the present disclosure. As shown in FIG. 8, a pressure of each of the hydrogen storage tanks before hydrogen refueling has a wide distribution of being within 3 MPa-20 MPa, while a pressure of each of the hydrogen storage tanks after hydrogen refueling is mainly concentrated in a range of 25 MPa-35 MPa, where the distribution is most concentrated around 35 MPa, indicating that the hydrogen refueling action of the distribution most concentrated around 35 MPa reaches a full hydrogen state. At the same time, there is a certain count of hydrogen refueling records near 30 MPa, indicating that some fuel cell vehicles are not completely filled during hydrogen refueling. Data points in other pressure ranges exhibit scattered distribution characteristics, reflecting different refueling strategies and demands existing in actual hydrogen refueling actions.

In some embodiments, the hydrogen refueling action features may include a distribution of single hydrogen refueling mass.

The distribution of single hydrogen refueling mass refers to a statistical distribution of hydrogen mass of single hydrogen refueling.

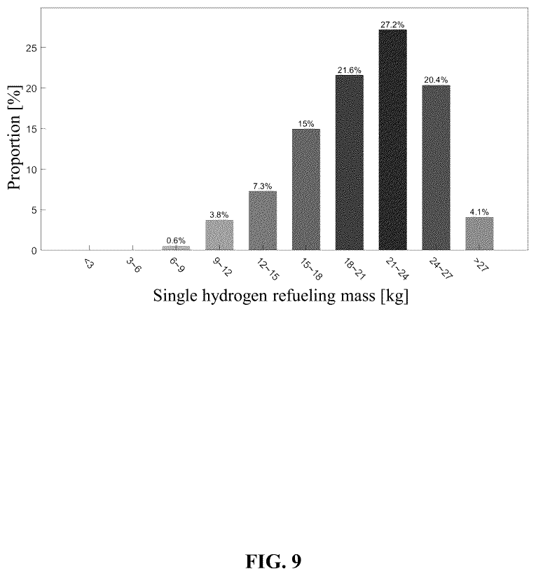

FIG. 9 is a schematic diagram illustrating a distribution of single hydrogen refueling mass of a fuel cell vehicle according to some embodiments of the present disclosure. As shown in FIG. 9, as the single hydrogen refueling mass increases, a proportion shows a trend of “first rising and then falling”. The hydrogen refueling mass is mainly concentrated in a range of 18 kg-27 kg, where a proportion of 21 kg-24 kg accounts the highest, reaching 27.2%. Proportions of two ranges, 18 kg-21 kg and 24 kg-27 kg, account 21.6% and 20.4%, respectively. In contrast, a situation where the single hydrogen refueling mass is less than 12 kg is relatively rare, accounting for only 4.4% of the total. This distribution characteristic indicates that most hydrogen refueling actions are concentrated in a medium-to-high hydrogen refueling mass range, reflecting a conventional demand level of the fuel cell vehicle for hydrogen fuel during actual operation.

In some embodiments, the hydrogen refueling action features may include a distribution of average hydrogen consumption per hundred kilometers.

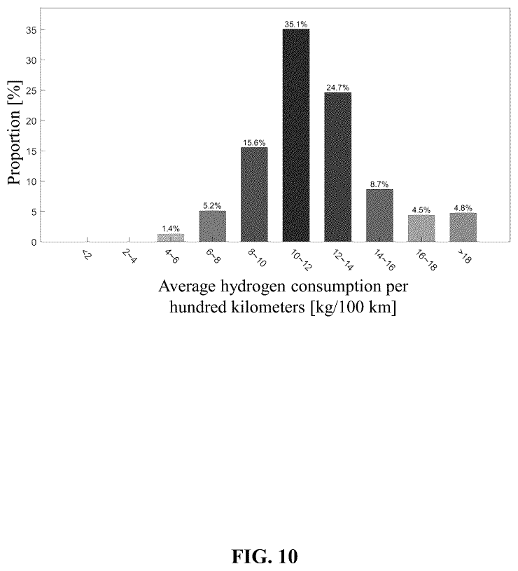

FIG. 10 is a schematic diagram illustrating a distribution of average hydrogen consumption per hundred kilometers of a fuel cell vehicle according to some embodiments of the present disclosure. As shown in FIG. 10, a proportion of the average hydrogen consumption of the fuel cell vehicle distributed in a range of 10 kg/100 km-12 kg/100 km is the highest, reaching 35.1%, followed by a range of 12 kg/100 km-14 kg/100 km. It is worth noting that hydrogen consumption levels of different fuel cell vehicles have obvious differences, mainly affected by a plurality of factors such as vehicle model, transportation load, and ambient temperature.

One or more embodiments of the present disclosure provide a non-transitory computer-readable storage medium. The storage medium stores computer instructions. When a computer reads the computer instructions from the storage medium, the computer executes the method for controlling the hydrogen refueling action of the fuel cell vehicle described above.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A system for controlling a hydrogen refueling action of a fuel cell vehicle, comprising a vehicle control unit, wherein the vehicle control unit is configured to:
obtain, from a big data platform of the fuel cell vehicle, a structural design parameter of a hydrogen system of the fuel cell vehicle and a driving data set of the fuel cell vehicle in a preset time period; wherein the structural design parameter of the hydrogen system of the fuel cell vehicle includes at least one of a count of hydrogen storage tanks, a nominal water volume of each of the hydrogen storage tanks, and a nominal operating pressure of each of the hydrogen storage tanks;
obtain a hydrogen refueling data set related to the hydrogen refueling action of the fuel cell vehicle based on the driving data set; wherein the hydrogen refueling data set of the hydrogen refueling action of the fuel cell vehicle includes at least one of an information sending time, a cumulative mileage, a maximum temperature in the hydrogen system, and a maximum hydrogen pressure;
identify, based on the hydrogen refueling data set, occurrence of the hydrogen refueling action of the fuel cell vehicle by using a preset judgement condition, and determine attribute change values of the fuel cell vehicle after the occurrence of the hydrogen refueling action of the fuel cell vehicle based on respective data rows before and after hydrogen refueling of the fuel cell vehicle;
calculate hydrogen refueling mass of the fuel cell vehicle based on the attribute change values of the fuel cell vehicle after the occurrence of the hydrogen refueling action of the fuel cell vehicle;
obtain a first hydrogen refueling feature set of the fuel cell vehicle based on the hydrogen refueling data set; wherein the first hydrogen refueling feature set of the fuel cell vehicle includes at least one of a pressure of each of the hydrogen storage tanks before hydrogen refueling of the fuel cell vehicle, a pressure of each of the hydrogen storage tanks after hydrogen refueling of the fuel cell vehicle, a temperature of each of the hydrogen storage tanks before hydrogen refueling of the fuel cell vehicle, and a temperature of each of the hydrogen storage tanks after hydrogen refueling of the fuel cell vehicle;
obtain a second hydrogen refueling feature set corresponding to all hydrogen refueling actions in the hydrogen refueling data set based on the hydrogen refueling data set and the first hydrogen refueling feature set of the fuel cell vehicle; wherein the second hydrogen refueling feature set includes at least one of a hydrogen refueling interval distance, a hydrogen refueling interval time, a count of hydrogen refueling operations, the hydrogen refueling mass, and average hydrogen consumption;
determine, based on the average hydrogen consumption and reference hydrogen consumption, whether the fuel cell vehicle is in a high hydrogen consumption state; and
in response to the fuel cell vehicle being in the high hydrogen consumption state, generate a consumption reduction command based on the average hydrogen consumption and the reference hydrogen consumption; and control, based on the consumption reduction command, a fuel cell control unit (FCU) to adjust an injection frequency of a hydrogen injector, and control a motor control unit (MCU) to set a peak threshold of a stator current to limit a maximum phase current of a motor.

2. The system according to claim 1, wherein the vehicle control unit is further configured to:
in response to the fuel cell vehicle being in the high hydrogen consumption state, construct a hydrogen consumption reference library of the fuel cell vehicle based on a plurality of historical second hydrogen refueling feature sets of the fuel cell vehicle, historical ambient temperatures, and historical road condition information;
determine a remaining hydrogen quantity of each of the hydrogen storage tanks based on pressure data and temperature data of each of the hydrogen storage tanks;
determine, based on road condition information and ambient temperatures through the hydrogen consumption reference library, predicted hydrogen consumption of the fuel cell vehicle in a future time period;
determine an injection frequency sequence and a peak threshold sequence based on the road condition information, the remaining hydrogen quantity, and the predicted hydrogen consumption;
generate a frequency control command and a peak control command based on the injection frequency sequence and the peak threshold sequence;
control, based on the frequency control command, the FCU to adjust the injection frequency of the hydrogen injector for at least one future moment; and
control, based on the peak control command, the MCU to set the peak threshold of the stator current for the at least one future moment.

3. The system according to claim 2, wherein the vehicle control unit is further configured to:
when the remaining hydrogen quantity is less than a preset hydrogen quantity threshold, determine a target hydrogen refueling station based on a mean value of hydrogen refueling interval distances in the plurality of historical second hydrogen refueling feature sets, the road condition information, and the remaining hydrogen quantity, and generate a navigation command to guide the fuel cell vehicle to the target hydrogen refueling station.

4. The system according to claim 3, wherein a duration of the preset time period is related to the predicted hydrogen consumption and the remaining hydrogen quantity.

5. The system according to claim 1, wherein the vehicle control unit is further configured to:
in response to the first hydrogen refueling feature set satisfying an overpressure condition, generate a mode switching command; and
force, based on the mode switching command, the fuel cell vehicle to switch to a limp mode, wherein the limp mode is that the fuel cell vehicle is forced to be limited to minimum speed driving.

6. The system according to claim 1, wherein the system further comprises a hydrogen refueling station control unit, and the hydrogen refueling station control unit is configured to:
in response to receiving a hydrogen refueling feature request, generate a hydrogen refueling feature of the fuel cell vehicle based on the structural design parameter, the first hydrogen refueling feature set, and the second hydrogen refueling feature set;
send the hydrogen refueling feature to a hydrogen dispenser; and
generate, by the hydrogen dispenser based on the hydrogen refueling feature, a hydrogen refueling pressure and a hydrogen refueling flow rate, and refuel the fuel cell vehicle based on the hydrogen refueling pressure and the hydrogen refueling flow rate.

7. The system according to claim 6, wherein the hydrogen refueling station control unit is further configured to:
in response to receiving a hydrogen refueling state request, determine a hydrogen refueling state of the fuel cell vehicle based on the first hydrogen refueling feature set and the second hydrogen refueling feature set;
send the hydrogen refueling state to the hydrogen dispenser; and
determine, by the hydrogen dispenser, whether to lock a hydrogen refueling nozzle based on the hydrogen refueling state.

8. The system according to claim 1, wherein to obtain a hydrogen refueling data set related to the hydrogen refueling action of the fuel cell vehicle based on the driving data set, the vehicle control unit is further configured to:
obtain, as the hydrogen refueling data set, n rows of data in the driving data set involving the hydrogen refueling action of the fuel cell vehicle, wherein the n rows of data are arranged in a sequence of sending times; wherein
in a row m of data in the hydrogen refueling data set, an information sending time is represented as Time_m, a cumulative mileage is represented as S_m, a maximum temperature in the hydrogen system is represented as Temp_m, and a maximum hydrogen pressure is represented as P_m, where values of Time_m, S_m, Temp_m, and P_m are not null sets and are not zero; and
in a row m−1 of data in the hydrogen refueling data set, an information sending time is represented as Time_m−1, a cumulative mileage is represented as S_m−1, a maximum temperature in the hydrogen system is represented as Temp_m−1, and a maximum hydrogen pressure is represented as P_m−1.

9. The system according to claim 8, wherein to identify, based on the hydrogen refueling data set, occurrence of the hydrogen refueling action of the fuel cell vehicle by using a preset judgement condition, and determine attribute change values of the fuel cell vehicle after the occurrence of the hydrogen refueling action of the fuel cell vehicle based on respective data rows before and after hydrogen refueling of the fuel cell vehicle, the vehicle control unit is further configured to:
if values of Time_m−1, S_m−1, Temp_m−1, and P_m−1 in the row m−1 of data in the hydrogen refueling data set are not null sets and are not zero, determine the row m−1 of data as a data row before the hydrogen refueling of the fuel cell vehicle;
if the values of Time_m−1, S_m−1, Temp_m−1, and P_m−1 in the row m−1 of data in the hydrogen refueling data set are null sets or are zero, trace forward a valid data row according to the sending time until the valid data row is found, wherein the valid data row is represented as a row m-a, and a is in a range of [1, 2, . . . , m−1], in the row m-a, an information sending time is Time_m-a, a cumulative mileage is S_m-a, a maximum temperature in the hydrogen system is Temp_m-a, and a maximum hydrogen pressure is P_m-a, and determine the row m-a of data as the data row before the hydrogen refueling of the fuel cell vehicle; wherein
when the hydrogen refueling action occurs for the first time in the hydrogen refueling data set, the count of hydrogen refueling is recorded as 1, and each subsequent hydrogen refueling action occurs, the count of hydrogen refueling is increased by 1.

10. The system according to claim 9, wherein to calculate hydrogen refueling mass of the fuel cell vehicle based on the attribute change values of the fuel cell vehicle after the occurrence of the hydrogen refueling action of the fuel cell vehicle, the vehicle control unit is further configured to:
the pressure of each of the hydrogen storage tanks before hydrogen refueling of the fuel cell vehicle being P_before, and P_before=P_m-a;
the pressure of each of the hydrogen storage tanks after hydrogen refueling of the fuel cell vehicle being P_after, and P_after=P_m;
the temperature of each of the hydrogen storage tanks before hydrogen refueling of the fuel cell vehicle being Temp_before, and Temp_before=Temp_m-a;
the temperature of each of the hydrogen storage tanks after hydrogen refueling of the fuel cell vehicle being Temp_after, and Temp_after=Temp_m;
calculate the hydrogen storage mass m_tank_before before the hydrogen refueling of the fuel cell vehicle, and the hydrogen storage mass m_tank_after after the hydrogen refueling of the fuel cell vehicle based on the pressure and the temperature of each of the hydrogen storage tanks before and after the hydrogen refueling of the fuel cell vehicle:
$$m\_tank \_before = \frac{P\_before \times V\_tank \times n\_tank \times {M}_{H 2}}{R \times Temp\_before} ,$$
where V_tank is the nominal water volume of each of the hydrogen storage tanks, n_tank is the count of hydrogen storage tanks, M_{H2} is molar mass of hydrogen, and R is an ideal gas constant;
$$m\_tank \_after = \frac{P\_after \times V\_tank \times n\_tank \times {M}_{H 2}}{R \times Temp\_after} ;$$
wherein the hydrogen refueling mass of the fuel cell vehicle is calculated based on the hydrogen storage mass after hydrogen refueling of the fuel cell vehicle and the hydrogen storage mass before hydrogen refueling of the fuel cell vehicle:
$$m\_tank \_addmass = m\_tank \_after - m\_tank \_before .$$

11. A method for controlling a hydrogen refueling action of a fuel cell vehicle, comprising:
obtaining, from a big data platform of the fuel cell vehicle, a structural design parameter of a hydrogen system of the fuel cell vehicle and a driving data set of the fuel cell vehicle in a preset time period; wherein the structural design parameter of the hydrogen system of the fuel cell vehicle includes at least one of a count of hydrogen storage tanks, a nominal water volume of each of the hydrogen storage tanks, and a nominal operating pressure of each of the hydrogen storage tanks;
obtaining a hydrogen refueling data set related to the hydrogen refueling action of the fuel cell vehicle based on the driving data set; wherein the hydrogen refueling data set of the hydrogen refueling action of the fuel cell vehicle includes at least one of an information sending time, a cumulative mileage, a maximum temperature in the hydrogen system, and a maximum hydrogen pressure;
identifying, based on the hydrogen refueling data set, occurrence of the hydrogen refueling action of the fuel cell vehicle by using a preset judgement condition, and determining attribute change values of the fuel cell vehicle after the occurrence of the hydrogen refueling action of the fuel cell vehicle based on respective data rows before and after hydrogen refueling of the fuel cell vehicle;
calculating hydrogen refueling mass of the fuel cell vehicle based on the attribute change values of the fuel cell vehicle after the occurrence of the hydrogen refueling action of the fuel cell vehicle;
obtaining a first hydrogen refueling feature set of the fuel cell vehicle based on the hydrogen refueling data set; wherein the first hydrogen refueling feature set of the fuel cell vehicle includes at least one of a pressure of each of the hydrogen storage tanks before hydrogen refueling of the fuel cell vehicle, a pressure of each of the hydrogen storage tanks after hydrogen refueling of the fuel cell vehicle, a temperature of each of the hydrogen storage tanks before hydrogen refueling of the fuel cell vehicle, and a temperature of each of the hydrogen storage tanks after hydrogen refueling of the fuel cell vehicle;
obtaining a second hydrogen refueling feature set corresponding to all hydrogen refueling actions in the hydrogen refueling data set based on the hydrogen refueling data set and the first hydrogen refueling feature set of the fuel cell vehicle; wherein the second hydrogen refueling feature set includes at least one of a hydrogen refueling interval distance, a hydrogen refueling interval time, a count of hydrogen refueling operations, the hydrogen refueling mass, and average hydrogen consumption;
determining, based on the average hydrogen consumption and reference hydrogen consumption, whether the fuel cell vehicle is in a high hydrogen consumption state; and
in response to the fuel cell vehicle being in the high hydrogen consumption state, generating a consumption reduction command based on the average hydrogen consumption and the reference hydrogen consumption and sending the consumption reduction command to a vehicle control unit; and controlling, by the vehicle control unit based on the consumption reduction command, a fuel cell control unit (FCU) to adjust an injection frequency of a hydrogen injector, and controlling a motor control unit (MCU) to set a peak threshold of a stator current to limit a maximum phase current of a motor.

12. The method according to claim 11, wherein the obtaining a second hydrogen refueling feature set corresponding to all hydrogen refueling actions in the hydrogen refueling data set based on the hydrogen refueling data set and the first hydrogen refueling feature set of the fuel cell vehicle includes:
determining the hydrogen refueling interval distance based on a cumulative mileage of the fuel cell vehicle when two adjacent hydrogen refueling actions occur:
$$H 2 \_add \_int \_distance = {S\_m}^{′} - S\_m ,$$
where H2_add_int_distance represents the hydrogen refueling interval distance, S_m′ represents a cumulative mileage of the fuel cell vehicle when a next hydrogen refueling action occurs, and S_m represents a cumulative mileage of the fuel cell vehicle when a current hydrogen refueling action occurs;
determining the hydrogen refueling interval time based on information sending times of the fuel cell vehicle when the two adjacent hydrogen refueling actions occur:
$$H2\_add \_int \_time = {Time\_m}^{′} - Time\_m ,$$
where H2_add_int_time represents the hydrogen refueling interval time, Time_m′ represents an information sending time of the fuel cell vehicle when the next hydrogen refueling action occurs, and Time_m represents an information sending time of the fuel cell vehicle when the current hydrogen refueling action occurs;
determining the average hydrogen consumption based on hydrogen mass consumed between the current hydrogen refueling action and the next hydrogen refueling action of the fuel cell vehicle and the hydrogen refueling interval distance:
$$H2\_comp \_rate = \frac{m\_tank \_mass \_comp}{H2\_add \_int \_distance} ,$$
where H2_comp_rate represents the average hydrogen consumption, m_tank_mass_comp represents the hydrogen mass consumed between the current hydrogen refueling action and the next hydrogen refueling action, a value of the hydrogen mass is equal to hydrogen storage mass of the fuel cell vehicle after hydrogen refueling for the current hydrogen refueling action minus hydrogen storage mass of the fuel cell vehicle before hydrogen refueling for the next hydrogen refueling action; and H2_add_int_distance represents the hydrogen refueling interval distance between the current hydrogen refueling action and the next hydrogen refueling action.

13. The method according to claim 11, further comprising:
in response to the fuel cell vehicle being in the high hydrogen consumption state, constructing a hydrogen consumption reference library of the fuel cell vehicle based on a plurality of historical second hydrogen refueling feature sets of the fuel cell vehicle, historical ambient temperatures, and historical road condition information;
determining a remaining hydrogen quantity of each of the hydrogen storage tanks based on pressure data and temperature data of each of the hydrogen storage tanks;
determining, based on road condition information and ambient temperatures through the hydrogen consumption reference library, predicted hydrogen consumption of the fuel cell vehicle in a future time period;
determining an injection frequency sequence and a peak threshold sequence based on the road condition information, the remaining hydrogen quantity, and the predicted hydrogen consumption;
generating a frequency control command and a peak control command based on the injection frequency sequence and the peak threshold sequence and sending the frequency control command and the peak control command to the vehicle control unit;
controlling, by the vehicle control unit based on the frequency control command, the FCU to adjust the injection frequency of the hydrogen injector for at least one future moment; and
controlling, by the vehicle control unit based on the peak control command, the MCU to set the peak threshold of the stator current for the at least one future moment.

14. The method according to claim 11, further comprising:
in response to the first hydrogen refueling feature set satisfying an overpressure condition, generating a mode switching command and sending the mode switching command to the vehicle control unit; and
forcing, by the vehicle control unit based on the mode switching command, the fuel cell vehicle to switch to a limp mode, wherein the limp mode is that the fuel cell vehicle is forced to be limited to minimum speed driving.

15. The method according to claim 11, further comprising:
in response to a hydrogen refueling station control unit receiving a hydrogen refueling feature request, generating a hydrogen refueling feature of the fuel cell vehicle based on the structural design parameter, the first hydrogen refueling feature set, and the second hydrogen refueling feature set;
sending the hydrogen refueling feature to a hydrogen dispenser; and
generating, by the hydrogen dispenser based on the hydrogen refueling feature, a hydrogen refueling pressure and a hydrogen refueling flow rate, and refueling the fuel cell vehicle based on the hydrogen refueling pressure and the hydrogen refueling flow rate.

16. The method according to claim 15, further comprising:
in response to the hydrogen refueling station control unit receiving a hydrogen refueling state request, determining a hydrogen refueling state of the fuel cell vehicle based on the first hydrogen refueling feature set and the second hydrogen refueling feature set;
sending the hydrogen refueling state to the hydrogen dispenser; and
determining, by the hydrogen dispenser, whether to lock a hydrogen refueling nozzle based on the hydrogen refueling state.

17. The method according to claim 11, wherein the obtaining a hydrogen refueling data set related to the hydrogen refueling action of the fuel cell vehicle based on the driving data set includes:
obtaining, as the hydrogen refueling data set, n rows of data in the driving data set involving the hydrogen refueling action of the fuel cell vehicle, wherein the n rows of data are arranged in a sequence of sending times; wherein
in a row m of data in the hydrogen refueling data set, an information sending time is represented as Time_m, a cumulative mileage is represented as S_m, a maximum temperature in the hydrogen system is represented as Temp_m, and a maximum hydrogen pressure is represented as P_m, where values of Time_m, S_m, Temp_m, and P_m are not null sets and are not zero; and
in a row m−1 of data in the hydrogen refueling data set, an information sending time is represented as Time_m−1, a cumulative mileage is represented as S_m−1, a maximum temperature in the hydrogen system is represented as Temp_m−1, and a maximum hydrogen pressure is represented as P_m−1.

18. The method according to claim 16, wherein the identifying, based on the hydrogen refueling data set, occurrence of the hydrogen refueling action of the fuel cell vehicle by using a preset judgement condition, and determining attribute change values of the fuel cell vehicle after the occurrence of the hydrogen refueling action of the fuel cell vehicle based on respective data rows before and after hydrogen refueling of the fuel cell vehicle includes:
if values of Time_m−1, S_m−1, Temp_m−1, and P_m−1 in the row m−1 of data in the hydrogen refueling data set are not null sets and are not zero, determining the row m−1 of data as a data row before the hydrogen refueling of the fuel cell vehicle;
if the values of Time_m−1, S_m−1, Temp_m−1, and P_m−1 in the row m−1 of data in the hydrogen refueling data set are null sets or are zero, tracing forward a valid data row according to the sending time until the valid data row is found, wherein the valid data row is represented as a row m-a, and a is in a range of [1, 2, . . . , m−1], in the row m-a, an information sending time is Time_m-a, a cumulative mileage is S_m-a, a maximum temperature in the hydrogen system is Temp_m-a, and a maximum hydrogen pressure is P_m-a, and determining the row m-a of data as the data row before the hydrogen refueling of the fuel cell vehicle; wherein
when the hydrogen refueling action occurs for the first time in the hydrogen refueling data set, the count of hydrogen refueling is recorded as 1, and each subsequent hydrogen refueling action occurs, the count of hydrogen refueling is increased by 1.

19. The method according to claim 17, wherein the calculating hydrogen refueling mass of the fuel cell vehicle based on the attribute change values of the fuel cell vehicle after the occurrence of the hydrogen refueling action of the fuel cell vehicle includes:
the pressure of each of the hydrogen storage tanks before hydrogen refueling of the fuel cell vehicle being P_before, and P_before=P_m-a;
the pressure of each of the hydrogen storage tanks after hydrogen refueling of the fuel cell vehicle being P_after, and P_after=P_m;
the temperature of each of the hydrogen storage tanks before hydrogen refueling of the fuel cell vehicle being Temp_before, and Temp_before=Temp_m-a;
the temperature of each of the hydrogen storage tanks after hydrogen refueling of the fuel cell vehicle being Temp_after, and Temp_after=Temp_m;
calculating the hydrogen storage mass m_tank_before before the hydrogen refueling of the fuel cell vehicle, and the hydrogen storage mass m_tank_after after the hydrogen refueling of the fuel cell vehicle based on the pressure and the temperature of each of the hydrogen storage tanks before and after the hydrogen refueling of the fuel cell vehicle:
$$m\_tank \_before = \frac{P\_before \times V\_tank \times n\_tank \times {M}_{H 2}}{R \times Temp\_before} ,$$
where V_tank is the nominal water volume of each of the hydrogen storage tanks, n_tank is the count of hydrogen storage tanks, M_{H2} is molar mass of hydrogen, and R is an ideal gas constant;
$$m\_tank \_after = \frac{P\_after \times V\_tank \times n\_tank \times {M}_{H 2}}{R \times Temp\_after} ;$$
wherein the hydrogen refueling mass of the fuel cell vehicle is calculated based on the hydrogen storage mass after hydrogen refueling of the fuel cell vehicle and the hydrogen storage mass before hydrogen refueling of the fuel cell vehicle:
$$m\_tank \_addmass = m\_tank \_after - m\_tank \_before .$$

20. A non-transitory computer-readable storage medium, comprising: computer instructions stored in the storage medium, wherein when a computer reads the computer instructions from the storage medium, the computer executes the method for controlling the hydrogen refueling action of the fuel cell vehicle according to claim 11.
